(19) United States
(12) Patent Application Publication
(10) Pub. No.: US 2015/0127468 A1
(43) Pub. Date: May 7, 2015

(54) USER ENGAGEMENT BASED NONGUARANTEED DELIVERY PRICING

(71) Applicant: Yahoo! Inc., Sunnyvale, CA (US)

(72) Inventors: Xing Yi, Milpitas, CA (US); Yan Jiao, London (GB); Jean-Marc Langlois, Menlo Park, CA (US); Prabhakar Krishnamurthy, Pleasanton, CA (US); Xiubo Geng, Beijing (CN)

(21) Appl. No.: 14/073,575

(22) Filed: Nov. 6, 2013

(51) Int. Cl. G06Q 30/02

(52) U.S. Cl. CPC G06Q 30/0273
USPC 705/14.69

(57) ABSTRACT

A system can include a processor configured to: receive user session data from a network, identify user session data associated with a creative, and determine user interaction information associated with the creative. The processor may also be configured to determine one or more of a mean, a variance, and a median of a distribution of the user interaction information associated with the creative. Also, the processor can be configured to determine expected user engagement associated with the creative according to one or more of the user interaction information, the mean, the variance and the median. The processor can also be configured to: determine a probability that the expected user engagement will be higher than actual user engagement according to the expected user engagement and determine an expected price associated with the creative according to the probability that the expected user engagement will be higher than actual user engagement.

### RELATED APPLICATIONS

The present application relates to applications entitled: “PRIORITIZING ITEMS FROM DIFFERENT CATEGORIES IN A NEWS STREAM,” (Atty. Dkt. YAHOP209) filed on ______, U.S. Ser. No. ______, now U.S. Pat. No. ______; “DWELL TIME BASED ADVERTISING,” (Atty. Dkt. YAHOP205) filed on Aug. 23, 2013, U.S. Ser. No. 13/975,151, now U.S. Pat. No. ______; “DISPLAY TIME OF A WEB PAGE,” (Atty. Dkt. YAHOP189) filed on Mar. 15, 2013, U.S. Ser. No. 13/843,433, now U.S. Pat. No. ______; each of which is incorporated by reference.

### BACKGROUND

This application relates to using online user engagement data, such as dwell time and click data, to perform nonguaranteed delivery (NGD) content pricing.

NGD advertising and content include a variety of payment models. Publishers, such as advertisers, can choose to pay per impression (CPM) of an item of content or advertising, pay per click (CPC) directed at an item of content or advertising, or pay per action (CPA) associated with an item of content or advertising. For example, in the NGD display ads market or a stream market, advertisers with different payment types may compete for a same ad slot. An auction mechanism for a slot may convert bids associated with these various payment models to a common base model, such as expected price per impression (eCPM) model. For example, a winner of an ad slot in an auction may be the advertiser with the highest eCPM bid.

### BRIEF DESCRIPTION OF THE DRAWINGS

The system may be better understood with reference to the following drawings and description. Non-limiting and non-exhaustive examples are described with reference to the following drawings. The components in the drawings are not necessarily to scale, emphasis instead being placed upon illustrating the principles of the system. In the drawings, like referenced numerals designate corresponding parts throughout the different views.

FIG. 1 illustrates a block diagram of an example information system that includes an example NGD pricing server.

FIG. 2 illustrates example streams of ad items, content items, and data items.

FIG. 3 illustrates a block diagram of an example information system that includes an example NGD pricing module that can be implemented by one or more servers, such as the NGD pricing server of FIG. 1.

FIG. 4 illustrates example operations performed by a data collection module of the NGD pricing module (such as the online activity collection module of FIG. 3).

FIG. 5 illustrates example operations performed by a statistical analysis module of the NGD pricing module (such as the statistical analysis module of FIG. 3).

FIG. 6 illustrates example operations performed by a price adjustment module of the NGD pricing module (such as the price adjustment module of FIG. 3).

### DETAILED DESCRIPTION

Subject matter will now be described more fully hereinafter with reference to the accompanying drawings, which form a part hereof, and which show, by way of illustration, specific examples. Subject matter may, however, be embodied in a variety of different forms and, therefore, covered or claimed subject matter is intended to be construed as not being limited to any examples set forth herein; examples are provided merely to be illustrative. Likewise, a reasonably broad scope for claimed or covered subject matter is intended. Among other things, for example, subject matter may be embodied as methods, devices, components, or systems. The following detailed description is, therefore, not intended to be limiting on the scope of what is claimed.

### Overview of User Engagement Based Nonguaranteed Delivery Pricing

An example system can include or be associated with a server including an online activity collection module. The online activity module may be configured to: receive user session data from a network, identify user session data associated with a creative, and determine dwell time information associated with the creative. The example system can also include or be associated with a server including a statistical distribution analysis module. The statistical distribution analysis module may be configure to: determine one or more of a mean, a variance, and a median of a distribution of the dwell time information associated with the creative, and determine expected dwell time associated with the creative according to one or more of the dwell time information, the mean, the variance and the median. The example system can also include or be associated with a server, including a server including a price adjustment module. The price adjustment module may be configured to: determine an expected price per impression (eCPM) associated with the creative according to the expected dwell time, determine a price to bid on the creative according to the eCPM, and transmit the bid to a content exchange network.

Another example can include a processor configured to: receive user session data from a network, identify user session data associated with a creative, and determine user interaction information associated with the creative. The processor may also be configured to determine one or more of a mean, a variance, and a median of a distribution of the user interaction information associated with the creative. Also, the processor can be configured to determine expected user engagement associated with the creative according to one or more of the user interaction information, the mean, the variance and the median. The processor can also be configured to: determine a probability that the expected user engagement will be higher than actual user engagement according to the expected user engagement, determine an expected price per impression (eCPM) associated with the creative according to the probability that the expected user engagement will be higher than actual user engagement, and determine a price to bid on the creative according to the eCPM. The processor can also be configured to transmit the bid to a content exchange network.

Another example can include a non-transitory computer readable medium comprising instructions when executed by a processor enable the processor to: receive user session data from a network, identify user session data associated with a creative, and determine user interaction information associated with the creative. The instructions can also be executable to: determine a user engagement level associated with the creative according to the user interaction information, determine an amount of impressions associated with the creative according to the user session data, and determine an expected price per impression (eCPM) associated with the creative according to the user engagement level and the amount of impressions. The instructions can also be executable to: determine a price to bid on the creative according to the eCPM, and transmit the bid to a content exchange network.

### Example Embodiments of User Engagement Based Nonguaranteed Delivery Pricing

In accordance with the systems, products, and methods disclosed herein, a module, such as a user engagement based NGD pricing module (NGD pricing module), can price one or more NGD content items, such as NGD ads, at an optimal price according to user interactions with the item(s) or content associated and/or linked with the item(s). Such user interactions, including dwell times, clicks, sharing of content, likes, and tweets, for example, can define user engagement with the item(s). Hereinafter, user engagement with the item(s) will be referred to as “user engagement”.

The NGD pricing module can be integrated into existing content and ad exchange systems, and the user engagement can be associated with Internet browsing session information, such as information on dwell time and clicks of online content items. The NGD pricing module can employ various techniques, including the technologies described herein. Also, other types of marketing optimizers may use the technologies and techniques described herein. For example, even though the methods and technologies described herein are especially useful for NGD content pricing, such methods and technologies can be used by any type of content pricing system, including systems that price guaranteed delivery content.

The functions described herein can apply to any type of content, such as an online advertisement within a session of a webpage view or consumed while viewing of an online stream. For example, the online advertisement can be viewed within a mobile webpage or mobile content stream. A view or any other type of user engagement or interaction can be quantified through a dwell time of a page or a stream. For the purposes of this disclosure, dwell time is the time during which a user interacts with a content item or an advertisement. For example, dwell time can be measured as the time between two interactions with content, such as two interactions with an advertisement on a webpage or within an online stream.

In an example, the NGD pricing module may include a data-driven tool for NGD pricing. This tool may enhance a CPC based pricing model with dwell time information as input to improve revenue generated from online ads and other types of online content. Besides improving revenue generated by an item of content, the enhancement is meant to increase user engagement with the item.

The eCPM of CPC pricing models in an NGD market may be computed by Formula 1.

eCPM(CPC)=p(click|impression,content)*b,
wherein p(click|impression,content) is the probability that an impression will result in a click, and
b is a bid or a selected price for an impression of a content item. (1)

Formula 1 uses a probability that an impression will result in a click. An alternative example can use a probability that a certain dwell time will occur. Also, Formula 1 could be modified to consider other forms of user engagement or interaction with online content.

Using dwell time instead of clicks may have advantages. For example, dwell time may be a more accurate measure of actual user engagement with a content item in some instances. For example, if a user is taking the time to read or view the content item, opposed to merely clicking on it, that item may be more engaging. In exemplary embodiments, dwell times and/or impressions resulting from clicks is considered in determining eCPM.

To enhance the effectiveness of eCPM with respect to actual user engagement or interaction, dwell time may be used by the NGD pricing module. Dwell time may be used solely or in combination with other measurements of user interaction or engagement, and the NGD pricing module can also use dwell time based user engagement to adjust an eCPM based bid for a CPC auction. Ads with short dwell times may be discounted, while ads with long dwell times may have a higher eCPM based bids. Whether a dwell time is considered long or short depends on context (such as context with respect to an associated campaign, a device displaying the ad, and the type of medium the ad is delivered). For a simple example, for article content items, the average dwell time may correlate to the length of the article. A long article may have higher short and long dwell time thresholds. Also, conservative fixed thresholds can be used for each context, or machine learning techniques to learn dynamic threshold functions in different contexts can be leveraged to determine engagement thresholds.

In an example, thresholds can be determined according to a mean, medium, and/or mode of engagement, such as a mode dwell time for an ad campaign. The threshold can be set at a point after the mean, medium, or mode. Also, a dwell time distribution or distributions for a determined baseline ad or webpage can be used as a threshold as well.

Also, from using dwell time or another form of quantifying user engagement or interaction, balance between driving long term user engagement with a content item and generating revenue may be achieved by allowing more engaging ads to win an auction. This promotes publishers, such as advertisers, to produce more engaging content. It also benefits a publisher by providing a way to evaluate content immediately from samples of user sessions with the content, and determine changes to or termination of poor performing content. Adding real-time functionality to the NGD price module allows for determining such changes to or termination of content sooner rather than later.

Additionally or alternatively, the eCPM of a content item can be automatically adjusted by the NGD pricing module, even with a low click through rate (CTR) associated with the item and/or small samplings of session data associated with the item.

Also, disclosed herein is an online information system that can provide online content, including advertisements, with or within search results, aggregated content, any other form of online content delivery, and any combination thereof. Such online content can be made available through webpages, mobile applications (“apps”), TV apps, or other audio or visual content services. There are many options for providing such content. For example, various types of advertising and/or search results can be provided on a same webpage as publisher's content. Publisher's content may include any combination of text, graphics, audio, video, or links to other content.

Advertisements are conventionally selected based on a variety of criteria including those specified by the advertiser. The search results are conventionally selected based on various criteria, including rules of a respective search engine. An advertiser or agent of the advertiser can define an advertising campaign and/or search engine marketing campaign to control how and when advertisements and/or search results are made available to users, even in a nonguaranteed delivery system.

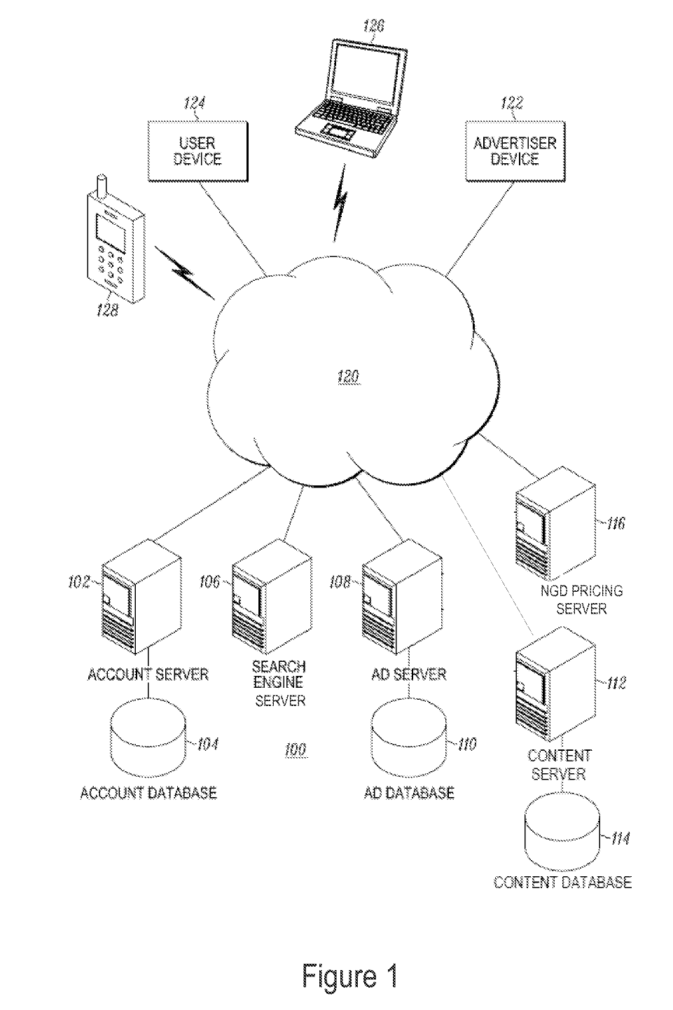

An online information system can warehouse user interaction and user interaction information, such as dwell times and clicks, in audience logs that may be used by the NGD pricing module. The information may be utilized to price content slot bids, such as price bids for nonguaranteed delivery of ads for an ad slot. The NGD pricing module can be implemented via one or more servers, such as an NGD pricing server. FIG. 1 illustrates how an example NGD pricing server 116 may be included in an example online information system.

FIG. 1 illustrates a block diagram of an example information system 100. The information system 100 in the example of FIG. 1 includes an account server 102, an account database 104, a search engine server 106, an ad server 108, an ad database 110, a content database 114, a content server 112, and the NGD pricing server 116. The NGD pricing server 116 is in data communication with the ad server 108, the ad database 110, the content server 112 and the content database 114. The NGD pricing server 116 may manage and monitor online traffic, including traffic associated with NGD advertising.

The information system 100 may be accessible over a network 120 by one or more advertiser devices, such as advertiser device 122 and by one or more user devices such as user device 124. In various examples of such an online information system, users may search for and obtain content from sources over the network 120 or from the content database 114. Advertisers may provide advertisements for placement on webpages and other communications sent over the network to user devices, such as the user device 124. The online information system can be deployed and operated by an online provider, such as Yahoo! Inc.

The account server 102 stores account information for advertisers. The account server 102 is in data communication with the account database 104. Account information may include one or more database records associated with each respective advertiser. Any suitable information may be stored, maintained, updated and read from the account database 104 by the account management server 102. Examples include advertiser identification information, advertiser security information, such as passwords and other security credentials, and account balance information.

The account server 102 may be implemented using any suitable device. The account management server 102 may be implemented as a single server, a plurality of servers, or any other type of computing device known in the art. Preferably, access to the account server 102 is accomplished through a firewall, not shown, which protects the account management programs and the account information from external tampering. Additional security may be provided via enhancements to the standard communications protocols, such as Secure HTTP or the Secure Sockets Layer.

The account server 102 may provide an advertiser front end to simplify the process of accessing the account information of an advertiser. The advertiser front end may be a program, application, or software routine that forms a user interface. In a particular example, the advertiser front end is accessible as a website with one or more webpages that an accessing advertiser may view on an advertiser device, such as advertiser device 122. The advertiser may view and edit account data and advertisement data using the advertiser front end. After editing the advertising data, the account data may then be saved to the account database 104.

The search engine server 106 may be a computer system, one or more servers, or any other computing device known in the art. Alternatively, the search engine server 106 may be a computer program, instructions, or software code stored on a computer-readable storage medium that runs on a processor of a single server, a plurality of servers, or any other type of computing device known in the art. The search engine server 106 may be accessed by user devices, such as the user device 124 operated by a user over the network 120. The user device 124 communicates a user query to the search engine server 106. The search engine server 106 locates matching information using any suitable protocol or algorithm and returns information to the user device 124. The search engine server 106 may be designed to help users find information located on the Internet or an intranet. In a particular example, the search engine server 106 may also provide to the user device 124 over the network 120 a webpage with content, including search results, information matching the context of a user inquiry, links to other network destinations, or information and files of information of interest to a user operating the user device 124, as well as a stream or webpage of content items and advertisement items selected for display to the user.

The search engine server 106 may enable a device, such as the user device 124 or any other client device, to search for files of interest using a search query. Typically, the search engine server 106 may be accessed by a client device via one or more servers or directly over the network 120. The search engine server 106 may include a crawler component, an indexer component, an index storage component, a search component, a ranking component, a cache, a profile storage component, a logon component, a profile builder, and one or more application program interfaces (APIs). The search engine server 106 may be deployed in a distributed manner, such as via a set of distributed servers, for example. Components may be duplicated within a network, such as for redundancy or better access.

The ad server 108 operates to serve advertisements to user devices, such as the user device 124. Advertisements include data defining advertisement information that may be of interest to a user of a user device. An advertisement may include text data, graphic data, image data, video data, or audio data. An advertisement may further include data defining one or more links to other network resources providing such data. The other locations may be other locations on the internet, other locations on an intranet operated by the advertiser, or any access.

For online information providers, advertisements may be displayed on webpages resulting from a user-defined search based, at least in part, upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users.

One approach to presenting targeted advertisements includes employing demographic characteristics (e.g., age, income, sex, occupation, etc.) for predicting user behavior, such as by group. Advertisements may be presented to users in a targeted audience based, at least in part, upon predicted user behavior.

Another approach includes profile-type ad targeting. In this approach, user profiles specific to a user may be generated to model user behavior, for example, by tracking a user's path through a website or network of sites, and compiling a profile based, at least in part, on pages or advertisements ultimately delivered. A correlation may be identified, such as for user purchases, for example. An identified correlation may be used to target potential purchasers by targeting content or advertisements to particular users.

Yet another approach includes targeting based on content of a webpage requested by a user. Advertisements may be placed on a webpage or in association with other content that is related to the subject of the advertisements. The relationship between the content and the advertisement may be determined in any suitable manner. The overall theme of a particular webpage may be ascertained, for example, by analyzing the content presented therein. Moreover, techniques have been developed for displaying advertisements geared to the particular section of the article currently being viewed by the user. Accordingly, an advertisement may be selected by matching keywords, and/or phrases within the advertisement and the webpage.

The ad server 108 includes logic and data operative to format the advertisement data for communication to the user device. The ad server 108 is in data communication with the ad database 110. The ad database 110 stores information, including data defining advertisements, to be served to user devices. This advertisement data may be stored in the ad database 110 by another data processing device or by an advertiser. The advertising data may include data defining advertisement creatives and bid amounts for respective advertisements. The NGD pricing module via the methods described herein, for example, may determine the bid amounts.

The advertising data may be formatted to an advertising item that may be included in a stream of content items and advertising items provided to a user device. The formatted advertising items are specified by appearance, size, shape, text formatting, graphics formatting and included information, which may all be standardized to provide a consistent look for all advertising items in the stream. At least some advertising items may have an associated bid amount, such as one determined by the NGD pricing module, and may be considered revenue generating items.

Further, the ad server 108 is in data communication with the network 120. The ad server 108 communicates ad data and other information to devices over the network 120. This information may include advertisement data communicated to a user device. This information may also include advertisement data and other information communicated with an advertiser device, such as the advertiser device 122. An advertiser operating an advertiser device may access the ad server 108 over the network to access information, including advertisement data. This access may include developing advertisement creatives, editing advertisement data, deleting advertisement data, setting and adjusting bid amounts and other activities. The ad server 108 then provide the ad items to other network devices, such as the NGD pricing server 116.

The ad server 108 may provide an advertiser front end to simplify the process of accessing the advertising data of an advertiser. The advertiser front end may be a program, application or software routine that forms a user interface. In one particular example, the advertiser front end is accessible as a website with one or more webpages that an accessing advertiser may view on the advertiser device. The advertiser may view and edit advertising data using the advertiser front end. After editing the advertising data, the advertising data may then be saved to the ad database 110 for subsequent communication in advertisements to a user device.

The ad server 108 may be a computer system, one or more servers, or any other computing device known in the art. Alternatively, the ad server 108 may be a computer program, instructions, and/or software code stored on a computer-readable storage medium that runs on a processor of a single server, a plurality of servers, or any other type of computing device known in the art.

The content server 112 is in data communication with the content database 114, the ad server 108 and the NGD pricing server 116. The content server 112 may access information about content items either from the content database 114 or from another location accessible over the network 120. The content server 112 communicates data defining content items and other information to devices over the network 120. This information may include content data communicated to a user device. This information may also include content data and other information communicated with a content provider operating a content provider device. A content provider operating a content provider device may access the content server 112 over the network 120 to access information, including content data. This access may include developing content items, editing content items, deleting content items, setting and adjusting bid amounts and other activities.

The content server 112 may provide a content provider front end to simplify the process of accessing the content data of a content provider. The content provider front end may be a program, application or software routine that forms a user interface. In a particular example, the content provider front end is accessible as a website with one or more webpages that an accessing content provider may view on the content provider device. The content provider may view and edit content data using the content provider front end. After editing the content data, the content data may then be saved to the content database 114 for subsequent communication to a user device.

The content server 112 includes logic and data operative to format content data and other information for communication to the user device. For example, the content data may be formatted to a content item that may be included in a stream of content items and advertisement items provided to a user device. The formatted content items are specified by appearance, size, shape, text formatting, graphics formatting and included information, which may all be standardized to provide a consistent look for all content items in the stream. In some examples, the content items have an associate bid amount that may be used for ranking or positioning the content items in a stream of items presented to a user device. In other examples, the content items do not include a bid amount, or the bid amount is not used for ranking the content items. Such content items may be considered non-revenue generating items. The content server 112 then provides the content items to other network devices, such as the ad server 108 and the NGD pricing server 116.

The account server 102, the search engine server 106, the ad server 108, the content server 112, and the NGD pricing server 116 may be implemented as any suitable computing device. A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Servers may vary widely in configuration or capabilities, but generally, a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

The account server 102, the search engine server 106, the ad server 108, the content server 112 and the NGD pricing server 116 may be implemented as online server systems or may be in communication with online server systems. An online server system may include a device that includes a configuration to provide content via a network to another device including in response to received requests for page views. An online server system may, for example, host a site, such as a social networking site, examples of which may include, without limitation, Flicker, Twitter, Facebook, LinkedIn, or a personal user site (such as a blog, vlog, online dating site, etc.). An online server system may also host a variety of other sites, including, but not limited to business sites, educational sites, dictionary sites, encyclopedia sites, wikis, financial sites, government sites, etc.

An online server system may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as an online server system include desktop computers, multiprocessor systems, microprocessor-type or programmable consumer electronics, etc. The online server system may not be under common ownership or control with the ad server 108, the content server 112 or the NGD pricing server 116.

The network 120 may include any data communication network or combination of networks. A network may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network, such as the network 120. Various types of devices may be made available to provide an interoperable capability for differing architectures or protocols. For example, a router may provide a link between otherwise separate and independent LANs. A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links, including satellite links, or other communication links or channels, such as may be known to those skilled in the art. Furthermore, a computing device or other related electronic devices may be remotely coupled to a network, such as via a telephone line or link, for example.

The advertiser device 122 includes any data processing device that may access the information system 100 over the network 120. The advertiser device 122 is operative to interact over the network 120 with the account server 102, the search engine server 106, the ad server 108, the NGD pricing server 116, content servers and other data processing systems. The advertiser device 122 may implement a web browser for viewing webpages and submitting user requests. The advertiser device 122 may communicate data to the information system 100, including data defining webpages and other information. The advertiser device 122 may receive communications from the information system 100, including data defining webpages and advertising creatives.

In some examples, content providers may access the information system 100 with content provider devices that are generally analogous to the advertiser devices in structure and function. The content provider devices provide access to content data in the content database 114, for example.

The user device 124 includes any data processing device that may access the information system 100 over the network 120. The user device 124 is operative to interact over the network 120 with the search engine server 106, the ad server 108, and the content server 112. The user device 124 may implement a web browser for viewing webpages and submitting user requests. A user operating the user device 124 may enter a search request and communicate the search request to the information system 100. The search request is processed by the search engine and search results are returned to the user device 124. In other examples, a user of the user device 124 may request data, such as a page of information from the online information system 100. The data instead may be provided in another environment, such as a native mobile application, TV application, or an audio application. The online information system 100 may provide the data or re-direct the browser to another website. In addition, the ad server may select advertisements from the ad database 110 and include data defining the advertisements in the provided data to the user device 124.

The advertiser device 122 and the user device 124 operate as a client device when accessing information on the information system 100. A client device, such as the advertiser device 122 and the user device 124 may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like. In the example of FIG. 1, both laptop computer 126 and smartphone 128 may be operated as either an advertiser device or a user device.

A client device may vary in terms of capabilities or features. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example. A client device, such as the advertiser device 122 and the user device 124, may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating one or more messages, such as via email, short message service (SMS), or multimedia message service (MMS), including via a network, such as a social network, including, for example, Facebook, LinkedIn, Twitter, Flickr, or Google+, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally stored or streamed video, or games. The foregoing is provided to illustrate that claimed subject matter is intended to include a wide range of possible features or capabilities.

Also, the disclosed methods and systems may be implemented partly in a server, a client device, a cloud computing environment, partially in a server and partially in a client device, or a combination of the server, the cloud computing environment and the client device.

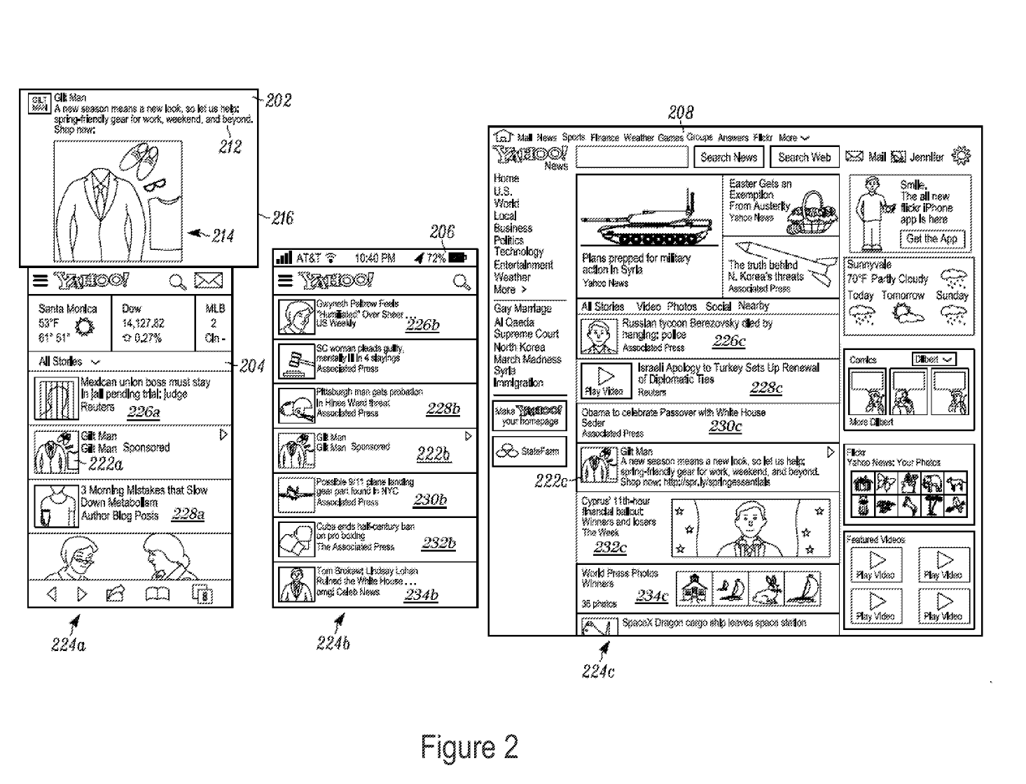

FIG. 2 illustrates streams of content items and data items displayed on selected user devices. The content items and data times displayed may be provided by the ad server 108 and the content server 112 of FIG. 1, and the pricing of these items, such as through bids, may be optimized via the NGD pricing module of the NGD pricing server 116. In FIG. 2, a display ad 202, which may be an NGD display ad, is illustrated as displayed on a variety of displays including a mobile web device display 204, a mobile application display 206 and a personal computer display 208. The mobile web device display 204 may be shown on the display screen of a mobile handheld device, such as a smartphone. The mobile application display 206 may be shown on the display screen of a portable device, such as a tablet computer. The personal computer display 208 may be displayed on the display screen of a personal computer (PC).

The display ad 202 is shown in FIG. 2 formatted for display on a user device but not as part of a stream to illustrate an example of the contents of such a display ad. The display ad 202 includes text 212, graphic images 214 and a defined boundary 216. The display ad 202 is developed by an advertiser for placement on a webpage sent to a user device operated by a user. The display ad 202 may be placed in a wide variety of locations on the webpage. However, the defined boundary 216 and the shape of the display ad must be matched to a space available on a webpage. If the space available has the wrong shape or size, the display ad 202 may not be useable.

To overcome these requirements and limitations, the display ad 202 may be reformatted or alternately formatted for inclusion in a stream of content items and advertising items including a stream ad incorporating contents of the display ad 202.

In these examples, the display ad is shown as a part of streams 224a, 224b, and 224c. The streams 224a, 224b, and 224c include a sequence of items displayed, one item after another, for example, down a webpage viewed on the mobile web device display 204, the mobile application display 206 and the personal computer display 208. The streams 224a, 224b, and 224c may include any type of items. In the illustrated example, the streams 224a, 224b, and 224c include content items and advertising items. For example, stream 224a includes content items 226a and 228a along with advertising item 222a; stream 224b includes content items 226b, 228b, 230b, 232b, 234b and advertising item 222b; and stream 224c includes content items 226c, 228c, 230c, 232c and 234c and advertising item 222c. With respect to FIG. 2, the content items are items published by non-advertisers. However, these content items may include advertising components. Each of the streams 224a, 224b, and 224c may include any number of content items and advertising items. In an example, the streams 224a, 224b, and 224c may be arranged to appear to the user to be an endless sequence of items so that as a user of a user device on which one of the streams 224a, 224b, or 224c is displayed scrolls the display, a seemingly endless sequence of items appears in the displayed stream.

The content items positioned in any of streams 224a, 224b, and 224c may include news items, business-related items, sports-related items, etc. Further, in addition to textual or graphical content, the content items of any stream may include other data as well, such as audio and video data or applications. Each content item may include text, graphics, other data, and a link to additional information. Clicking or otherwise selecting the link re-directs the browser on the user's device to a webpage referred to as a landing page that contains the additional information.

Stream ads like the advertising items 222a, 222b, and 222c, which may be NGD stream ads, may be inserted into the stream of content, supplementing the sequence of related items, providing a more seamless experience for end users. Similar to content items, the advertising items may include textual or graphical content as well as other data, such as audio and video data or applications. Each advertising item 222a, 222b, and 222c may include text, graphics, other data, and a link to additional information. Clicking or otherwise selecting the link re-directs the browser on the user's device to a webpage referred to as a landing page.

While the example streams 224a, 224b, and 224c are shown with a single visible advertising item 222a, 222b, and 222c, respectively, any number of advertising items may be included in a stream of items. Also, the advertising items may be slotted within the content, such as slotted the same for all users or slotted based on personalization or grouping, such as grouping by audience members or content. Adjustments of the slotting may be according to various dimensions and algorithms. This concept of slotting is just one of many Internet marketing strategies that can be optimized by the NGD pricing module or one of the other systems, modules, or operations described herein.

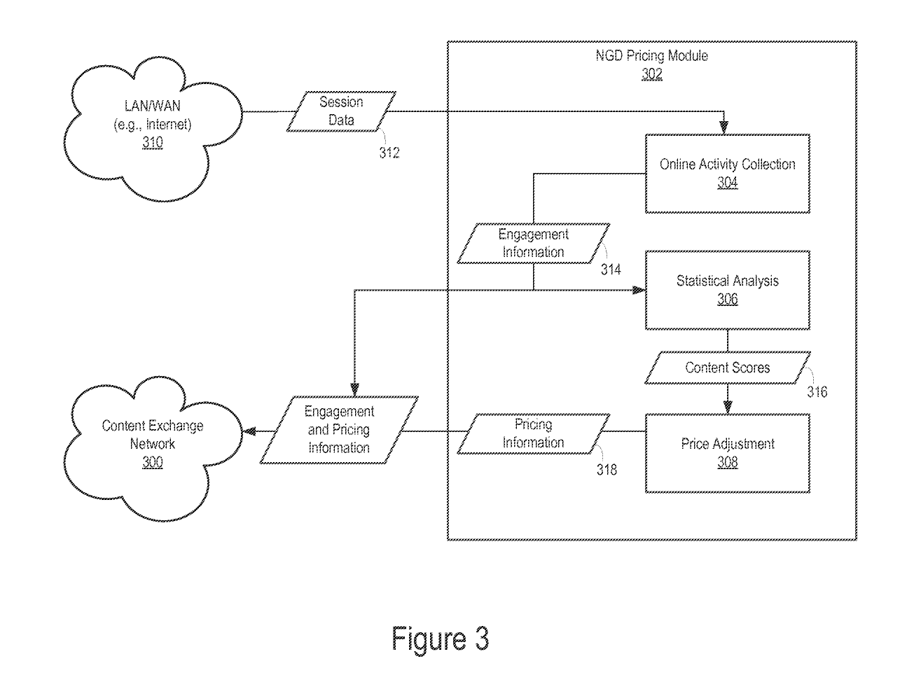

FIG. 3 illustrates sub-modules included in and/or communicatively coupled with a NGD pricing module, such as a NGD pricing module associated with or included in the NGD pricing server 116 of FIG. 1. Each of the sub-modules may be hosted by one or more servers, such as one or more of the servers of FIG. 1. The sub-modules may be integrated into a content exchange network 300, such as an NGD ad exchange, so that historical and/or real-time user engagement and interaction data (such as dwell time and click information) can be used for enhancing pricing of content, such as pricing NGD ads competing for slots in an auction system. The sub-modules may be integrated via the NGD pricing module 302 via one or more servers. The sub-modules may include an online activity collection module 304, a statistical analysis module 306, and a price adjustment module 308 for leveraging user engagement or interaction to manually and/or automatically adjust content pricing or valuation, such as automatically adjusting eCPM based auction prices for NGD content.

FIG. 3 illustrates the online activity collection module 304 communicatively coupled to a LAN/WAN 310 (such as network 120 of FIG. 1) that may include the Internet. From the LAN/WAN 310 the online activity collection module 304 receives online user session data 312, such as web browsing session data. The online activity collection module 304 can then determine and communicate user interaction information 314, such as dwell time information, to the statistical analysis module 306 and the content exchange network 300. The statistical analysis module 306 can determine content scores 316 according to the user interaction information 314. The content scores 316 may reflect user engagement levels with respect to online content items, such as NGD ads. From the content scores 316 respective pricing information for the content is determined by the price adjustment module 308. The pricing information 318 can then be communicated to the content exchange network 300, such as in the form of respective bids for impressions of the content in an auction system. For example, the content scores 316 may be derived from eCPM, and the pricing information 318 may be derived from the content scores.

To incorporate user engagement signals, such as dwell times, into eCPM computation for various types of online marketing campaigns, such as CPC campaigns in NGD markets, three modules can be used. These three modules can include the online activity collection module 304, the statistical analysis module 306, and/or the price adjustment module 308. The first of the three modules (the first module) can include or be implemented through the online activity collection module 304. The second of the three modules (the second module) can include or be implemented through the statistical analysis module 306. The third of the three modules (the third module) can include or be implemented through the price adjustment module 308.

In an example, the first module may include a system of collecting stream ads per creative per click event dwell time information. In such an example, this module can collect such information via systems and methods described in “DISPLAY TIME OF A WEB PAGE,” (Atty. Dkt. YAHOP189) filed on Mar. 15, 2013, U.S. Ser. No. 13/843,433, now U.S. Pat. No. ______, or other systems and methods, to compute per-item per-user dwell time information, for example.

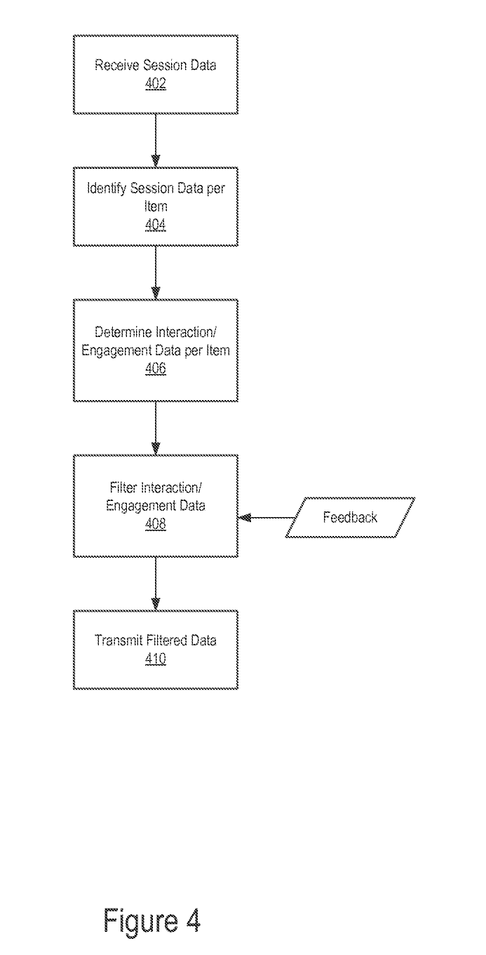

FIG. 4 illustrates example operations performed by the first module of the NGD pricing module (such as the online activity collection module 304). At 402, the first module may receive user session data from a network, such as the LAN/WAN 310. The session data may be associated with NGD content and can include click and dwell time information, such as click and dwell time information associated with a creative. A creative can include at least one of a non-ad content item, an ad item, a streamed item, a page displayed item, or any combination thereof. For example a creative can be a group of items or a single item, such as one or more of the ad items, contents items, and data items of FIG. 2.

At 404, the first module can identify session data associated with a content item broadcasted by the network according to a corresponding identifier. Session data corresponding to a content item may be associated with the content item through metadata within a tag, a header, or any other known forms of implementing metadata based data associations. Each content item may be associated with a unique identifier. At 406, the first module can determine user interaction information associated with the content item, such as dwell times and clicks associated with the item. The content item may be any type of online content item, including any type of advertisement and non-advertisement item.

At 408, the user interaction information can be filtered by the first module. The filtering of this information can be according to feedback from the second module or other aspects or modules associated with the NGD pricing module. At 410, the filtered interaction information can be transmitted to other components of system associated with the NGD pricing module, such as the second module for statistical analysis.

In an example, the second module may include statistical distribution analysis aspects, which can compute dwell time and other user engagement distributions associated with the creative. Such analysis can use the raw session data collected at the first module or the information filtered by the first model (such as the data filtered at 408 and transmitted at 410).

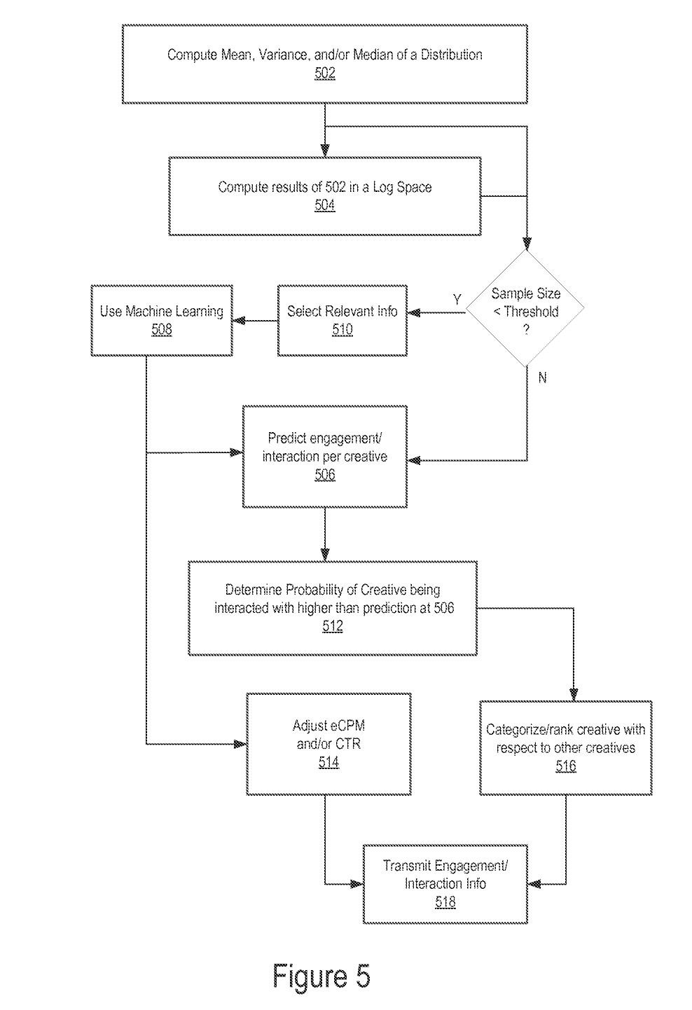

FIG. 5 illustrates example operations performed by the second module of the NGD pricing module (such as the statistical analysis module 306). The second module can compute a mean, a variance, and/or a median of a dwell time and/or other engagement distribution for the creative using raw session data or preprocessed data focused on identifying user interaction information, at 502. Additionally or alternatively, the second module can compute a mean, variance, and median of the dwell time and/or other engagement distribution of the creative in a log space (such as LOG(dwell time)), at 504. This may facilitate each user engagement signal, such as an ad click or dwell time, being associated with measurable non-binary signals, such as graded labels or dwell time based scores. For example, user engagement levels can be divided into multiple grades or quantiles (such as a first quantile, a second quantile, etc.) of dwell times in a log space. The second module can then determine the engagement grade or quantile for an engagement. Grades or quantiles may be increased by using the integer part of log(dwell time) as the engagement level, for example.

In another example, real-time per creative dwell time mean and/or variance in a log space can be a approximated via systems and methods disclosed in “PRIORITIZING ITEMS FROM DIFFERENT CATEGORIES IN A NEWS STREAM,” (Atty. Dkt. YAHOP209) filed on ______, U.S. Ser. No. ______, now U.S. Pat. No. ______.

Also, the second module can predict an expected dwell time and/or other engagement associated with the creative, at 506. This is even the case where there is none or little historical click and/or dwell time information. Where there is little information, such as a sampling level that does not meet a threshold, the second module can use machine learning models trained on other relevant dwell time, other user interaction information, and/or attributes of the creative (such as ad length or ad category), at 508. The second module can also leverage advanced machine learning techniques and/or linear regression techniques to predict the expected dwell time for each new creative. Machine learning techniques may include gradient boosting decision trees and regression tools such as linear regression or logistic regressions, for example. The other historical click and/or dwell time information, or training data, can be selected from one or more similar creatives in order to improve the accuracy of the prediction at 506. Similarity between creatives can be determined through known methods, and in selection of the other relevant dwell time and/or user interaction information at 510, a threshold value can be predetermined with respect to the amount of similarity desired to filter out non-relevant information.

The probability of a creative being interacted with higher than its predicted expected engagement (such as expected CTR and/or dwell time) can be computed according to Formulas 2 and 3 by the second module, at 512. The probability of a creative being interacted with higher than its predicted expected engagement can represent expected engagement for a creative relative to other similar creatives.

z=(PEE−DTM)/DTV, (2)
wherein PEE is predicted expected engagement,
wherein DTM is real-time dwell time mean, and
wherein DTV is real-time dwell time variance.

P=1−phi(z)¹, (3)
wherein P is the probability of a creative being interacted with
higher than its predicted expected engagement.
   P can be used as a discounting factor for adjusting the eCPM, such as in the case of using Formula 4 to determine eCPM. Also, a function of P (e.g., f(P)) can be used as well. The function of P can be linear or nonlinear.

In this example, when there is limited engagement data for a creative (such as when an ad or ad campaign is new), a student distribution model can be used by the second module to determine eCPM.

$$\begin{matrix}eCPM = P * CTR * bid \\ = P * p ( click \vert impression , ads ) * bid .\end{matrix} \qquad ( 4 )$$

The second module can also adjust the eCPM and/or the CTR of campaigns or creatives at 514, such as CPC campaigns, using the machine learning approach at 508. For example, the second module can use known machine learning techniques, such as gradient boosting decision trees to predict the eCPM and/or CTR of a creative. CTR can be computed directly from a click signal. In general, user engagement signals can be used to further weight and/or adjust the CTR and/or the eCPM, such as shown by Formula 5.

adjusted CTR or eCPM=Sum(weight of click or other interaction)/impressions,
wherein adjusted CTR or eCPM is an adjusted CTR or eCPM for a creative,
wherein weight of click or other interaction=F(user engagement level),
wherein user engagement level is a measure of user interaction and/or engagement with a creative and F can be a linear or nonlinear function to adjust the impact of engagement on the adjusted CTR or eCPM and final eCPM price,
wherein Sum(weight of click or other interaction) is the sum of weights associated with different types of engagement and interaction associated with a creative, and
wherein impressions is an amount of impressions of the creative. (5)

Also, the second module can use an online learning algorithm to update the CTR prediction model according to received user engagement signals, such as signals collected by the first module. This can be done for each creative. This model and the others can continually receive real-time feedback from the first module and can adjust eCPM, and/or CTR, according to such feedback. With time, the model should become more accurate due to more feedback over time. This concept of feedback also applies to the machine learning at 508.

Alternatively, the third module can adjust eCPM, and/or CTR, using the aforementioned modules.

Another function of the second module is to differentiate between engaging and ignored creatives at 516. One purpose of these models is to determine relative levels of engagement of a creative with respect to competing creatives, such as providing scores for ranking creatives competing for a bid on a slot. Also, creatives with a low rank with respect to a threshold or competing creatives can be discounted, and creatives with a high rank with respect to a threshold or competing creatives can be charged a premium. The aforementioned models can be combined in various manners to provide different results, and such combining can be automated. This automation of combining models can be directed by the second module, according feedback received from the first module and/or the third module, for example.

Then, at 518, data associated with the adjusted eCPM and/or CTR and/or the rated creatives is transmitted to other components of system associated with the NGD pricing module, such as the third module for price adjustment.

The third module of the NGD pricing module can include a price adjustment module. Additionally or alternatively the third module may include a bidding price component, which can control user engagement signal enhanced eCPM-based bidding computations for a creative and/or groupings of creatives, such as one or more ads to be published by an ad exchange. As shown in FIG. 3, pricing information and user interaction information can be directed to one or more servers of a content exchange network 300 from a price adjustment module. For a creative or campaign, the third module can also base eCPM on respective dwell time distribution, respective predicted expected dwell times, and other factors determined by the second module. Exemplary determination and adjustment of eCPM can be done using any combination of models described herein, and can be performed by the second or the third module.

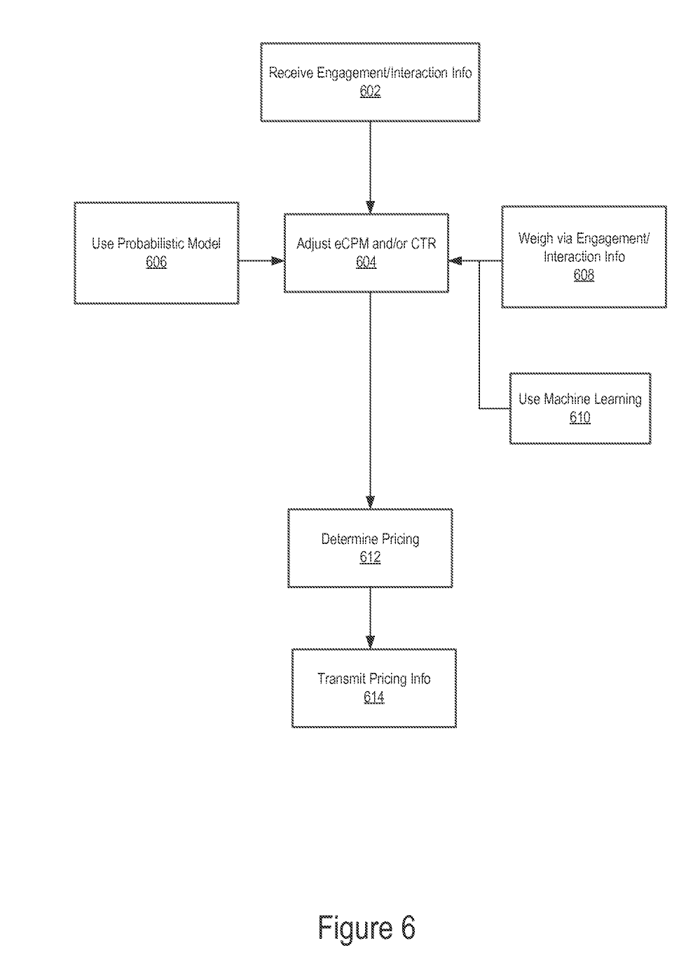

FIG. 6 illustrates example operations performed by the third module of the NGD pricing module (such as the price adjustment module 308). At 602, the third module can receive the user interaction information, such as from the second module. The third module can use the user interaction information to adjust the eCPM and/or CTR for the displayed creative, at 604. For example, adjustment by the third module can be based on a probabilistic dwell time distribution model at 606. This type of adjustment can compute an eCPM price adjustment factor correlated to the probability that a creative will have a better than average user engagement level.

The third module can also use user interaction information to weigh clicks or dwell times at 608. Using such a weight, the third module can determine an adjusted CTR (such as a discounted CTR), for example. The third module can also use machine learning techniques, such as regression approaches and online learning approaches, to determine adjusted CTR, at 610, so that the adjusted CTR can be an input for determining eCPM based pricing, such as in determining eCPM based pricing for NGD CPC contracts. At 612, the third module determines a price and/or a bid for the creative based on the adjusted eCPM and/or CTR. At 614, the third module can transmit the pricing and/or bid information to a content exchange network, such as the content exchange network 300 of FIG. 3.

The third module can use an adjusted eCPM of a creative as a bidding price or at least a basis for a bidding price of the creative to enter a slot, such as an ad slot. With this arrangement, the NGD pricing module, such as the NGD pricing module 302, can automatically promote more engaging content and demote non-engaging content over time. Even creatives associated with a limited amount of session data can be promoted and demoted to a lesser degree. In other words, promotion and demotion of a creative or a bid price of a creative can be based partially on the amount of historical data available associated with that creative. Less engaging creatives will have a lower probability of winning a slot opportunity in an auction. Also, by adjusting price for less engaging creatives, publishers of the creative will take less risk in placing their creatives in streams and web pages.

The pricing module is also useful when used with a unified market place stream and/or various social media streams. For example, the pricing module is useful with “PRIORITIZING ITEMS FROM DIFFERENT CATEGORIES IN A NEWS STREAM,” (Atty. Dkt. 12729-1122) filed on Apr. 29, 2013, U.S. Ser. No. 13/872,436, now U.S. Pat. No. ______. It can be useful in that the module can reduce a publisher's risk of losing users long term when adjusting strategies for delivering content. The ability to adjust eCPM in a stream is especially useful considering the high CTRs experienced in stream environments.

1. A system, comprising:
one or more processors and a non-transitory storage medium comprising program logic for execution on the processors, the program logic comprising:
an online activity collection module, comprising instructions executable to determine dwell time information from user session data associated with a creative;
a statistical distribution analysis module configured to receive the dwell time information from the online activity module and determine one or more of a mean, a variance, and a median of a distribution of the dwell time information associated with the creative and expected dwell time associated with the creative; and
a price adjustment module configured to receive the expected dwell time associated with the creative and determine an expected price associated with the creative according to the expected dwell time.

2. The system of claim 1, wherein the online activity collection module is configured to filter the dwell time information according to the one or more of the dwell time information, the mean, the variance and the median.

3. The system of claim 1, wherein the determination of the one or more of a mean, a variance, and a median of a distribution of the dwell time information is in a log space.

4. The system of claim 1, wherein the statistical distribution analysis module is configured to:
identify sample level of the dwell time information;
determine whether the sample level is greater than a threshold; and
determine the expected dwell time according to one or more of attributes of the creative and dwell time information of a similar creative, wherein the similar creative being objectively similar according to a creative similarity model, and wherein the sample level is not greater than a threshold.

5. The system of claim 1, wherein the price adjustment module is configured to determine the price according to machine learning.

6. The system of claim 1, wherein the price adjustment module is configured to determine the price according to a linear regression technique.

7. The system of claim 1, wherein the expected price is an expected price per impression (eCPM).

8. A method, comprising:
receiving, at a processor, user session data from a network;
identifying, by the processor, user session data associated with a creative;
determining, by the processor, user interaction information associated with the creative;
determining, by the processor, one or more of a mean, a variance, and a median of a distribution of the user interaction information associated with the creative;
determining, by the processor, expected user engagement associated with the creative according to one or more of the user interaction information, the mean, the variance and the median;
determining, by the processor, a probability that the expected user engagement will be higher than actual user engagement according to the expected user engagement; and
determining, by the processor, an expected price associated with the creative according to the probability that the expected user engagement will be higher than actual user engagement.

9. The method of claim 8, comprising determining the probability that the expected user engagement will be higher than actual user engagement according to a mean of a distribution of the expected user engagement and a variance of the distribution of the expected user engagement.

10. The method of claim 8, wherein the expected user engagement is based on real-time data.

11. The method of claim 8, wherein the expected user engagement is based on historical data.

12. The method of claim 8, wherein the determining the probability that the expected user engagement will be higher than actual user engagement is according to the following formulas:
z=(PEE−DTM)/DTV,
wherein PEE is the expected user engagement,
wherein DTM is a mean of a distribution of the expected user engagement,
wherein DTV is a variance of the distribution of the expected user engagement, and
P=1−phi(z),
wherein P is the probability that the expected user engagement will be higher than actual user engagement associated with the creative.

13. The method of claim 8, wherein the expected price is an expected price per impression (eCPM), and wherein the determining the expected price is according to a bid and a click through rate associated with the creative.

14. The method of claim 8, wherein the expected price is an expected price per impression (eCPM), and wherein the determining the expected price is according to the probability that the expected user engagement will be higher than the actual user engagement (P), a bid, a click through rate associated with the creative (CTR), and the following formula: eCPM=P×CTR×bid.

15. The method of claim 8, wherein the expected user engagement includes expected dwell time and wherein the user interaction information includes dwell time information.

16. The method of claim 8, wherein the expected price is an expected price per impression (eCPM).

17. A non-transitory computer readable medium comprising instructions, the instructions when executed by a processor enabling the processor to:
receive user session data from a network;
identify user session data associated with a creative;
determine user interaction information associated with the creative;
determine a user engagement level associated with the creative according to the user interaction information;
determine an amount of impressions associated with the creative according to the user session data; and
determine an expected price associated with the creative according to the user engagement level and the amount of impressions.

18. The non-transitory computer readable medium of claim 17, wherein the expected price is an expected price per impression (eCPM), and wherein the determination of the expected price is according to the user engagement level (weight), the amount of impressions (impressions), and the following formula:
eCPM=Sum(weight)/impressions, wherein Sum(weight) is a sum of weights associated with different types of engagement and interaction associated with the creative.

19. The non-transitory computer readable medium of claim 17, wherein the user engagement level includes dwell time level and wherein the user interaction information includes dwell time information.

20. The non-transitory computer readable medium of claim 17, wherein the expected price is an expected price per impression (eCPM).
